(19) United States
(12) Patent Application Publication
(10) Pub. No.: US 2020/0003902 A1
(43) Pub. Date: Jan. 2, 2020

(54) LIDAR SYSTEM AND AUTONOMOUS DRIVING SYSTEM USING THE SAME

(71) Applicant: LG ELECTRONICS INC., Seoul (KR)

(72) Inventor: Jejong Lee, Seoul (KR)

(21) Appl. No.: 16/558,031

(22) Filed: Aug. 30, 2019

(30) Foreign Application Priority Data
Aug. 5, 2019 (KR) 10-2019-0095145

(51) Int. Cl. G01S 17/93; G01S 17/02; G01S 17/89; G06T 19/00; G01S 7/48

(52) U.S. Cl. CPC G01S 17/933; G01S 17/023; G01S 17/89; G01S 7/51; G01S 7/4808; B64C 2201/14; G06T 19/006

(57) ABSTRACT

A lidar system includes: light sources generating light of a linear light source type; a light emission unit including a diffractive optical element disposed ahead of the light sources and separating incident light from the light sources into point light sources, and a scanner moving the light separated by the diffractive optical element, and radiating light of a point light source to an object; and a reception sensor converting light received after reflection by the object into an electrical signal. Spectrum angles of point light sources that have passed through the diffractive optical element may be different according to a position of the diffractive optical element. According to the lidar system, an autonomous vehicle, AI device, and/or external device may be linked with an artificial intelligence module, drone ((Unmanned Aerial Vehicle, UAV), robot, AR (Augmented Reality) device, VR (Virtual Reality) device, a device associated with 5G services, etc.

### CROSS-REFERENCE TO RELATED APPLICATION

This application claims the benefit of Korean Patent Application No. 10-2019-0095145 filed on Aug. 5, 2019, the entire contents of which is incorporated herein by reference for all purposes as if fully set forth herein.

### BACKGROUND

### Field of the Disclosure

The present disclosure relates to an autonomous driving system and a control method thereof and, more particularly, to a lidar system including a diffraction optical element that separates laser beams from light sources, and an autonomous driving system using the lidar system.

### Description of the Background

Vehicles, in accordance with the prime mover that is used, can be classified into an internal combustion engine vehicle, an external combustion engine vehicle, a gas turbine vehicle, an electric vehicle or the like.

An autonomous vehicle refers to a vehicle that can be driven by itself without operation by a driver or a passenger and an autonomous driving system refers to a system that monitors and controls such an autonomous vehicle so that the autonomous vehicle can be driven by itself.

Since autonomous vehicles are driven without intervention of a driver, the autonomous vehicles need various sensors to quickly and accurately sense surrounding landforms and objects in real time.

A lidar (Light Imaging Detection and Ranging) system radiates laser light pulses to an object and analyzes light reflected by the object, thereby being able to sense the size and disposition of the object and to measure the distance from the object.

### SUMMARY

A lidar system can be classified into a motor rotation type and a non-motor rotation type. The motor rotation type includes a driving system including a motor, several laser light sources, and several reception sensors, so it is expensive and difficult to downsize.

The non-motor rotation type includes a scanner that moves a light beam radiated as laser light pulses. The scanner may be implemented by a galvano scanner or a MEMS (MicroElectro Mechanical Systems) scanner. The scanner scans an object by two-axially, that is, vertically and horizontally moving a light beam from a light source.

The non-motor rotation type can be classified into a linear light source type and a point light source type. The linear light source type is low in efficiency and the light intensity of a linear light source is not uniform, so the signal-to-noise ratio (SNR) of received signals is low and there is a problem of cross-talk between adjacent sensors of a reception sensor. The point light source type uses two scanners for vertical and horizontal scanning, has a low scan speed, and has a large scan element, so mass production is difficult and it is difficult to reduce the costs.

An object of the present disclosure is to solve the necessities and/or problems described above.

An object of the present disclosure is to provide a lidar system that can minimize cross-talk, can be implemented in a small and light size, and can cope with various use cases, and an autonomous driving system using the lidar system.

The objects of the present disclosure are not limited to the objects described above and other objects will be clearly understood by those skilled in the art from the following description.

A lidar system according to an embodiment of the present disclosure includes: two or more light sources that generate light of a linear light source type; a light emission unit that includes a diffractive optical element disposed ahead of the light sources and separating incident light from the light sources into several point light sources, and a scanner moving the light separated by the diffractive optical element, and radiates light of a point light source to an object; and a reception sensor that converts light received after reflected by the object into an electrical signal.

Spectrum angles of point light sources that have passed through the diffractive optical element may be different in accordance with a position of the diffractive optical element.

An autonomous driving system according to an embodiment of the present disclosure includes an autonomous device that receives sensor data input from the lidar system and reflects information of the object to movement control of the vehicle.

### BRIEF DESCRIPTION OF THE DRAWINGS

Accompanying drawings included as a part of the detailed description for helping understand the present disclosure provide embodiments of the present disclosure and are provided to describe technical features of the present disclosure with the detailed description.

FIG. 1 is a block diagram of a wireless communication system to which methods proposed in the disclosure are applicable.

FIG. 2 is a diagram showing an example of a signal transmission/reception method in a wireless communication system.

FIG. 3 shows an example of basic operations of a user equipment and a 5G network in a 5G communication system.

FIG. 4 shows an example of a basic operation between vehicles using 5G communication.

FIG. 5 is a diagram showing a vehicle according to an embodiment of the present disclosure.

FIG. 6 is a control block diagram of the vehicle according to an embodiment of the present disclosure.

FIG. 7 is a control block diagram of an autonomous device according to an embodiment of the present disclosure.

FIG. 8 is a signal flow diagram of an autonomous device according to an embodiment of the present disclosure.

FIG. 9 is a diagram showing a V2X application.

FIG. 10 is a diagram showing a resource allocation method in V2X sidelink.

FIG. 11 is a block diagram showing a lidar system according to an embodiment of the present disclosure.

FIG. 12 is a diagram showing light sources and a diffraction element.

FIG. 13 is a diagram showing an example of a diffraction element.

FIG. 14 is a diagram showing an example of a light sensor array of a reception sensor.

FIGS. 15 and 16 are diagrams showing laser beams that are separated by a diffraction optical element and light spots on a light sensor array.

FIG. 16 is a block diagram showing a light source control unit.

FIG. 17 is a diagram showing an example when a lidar system is mounted at the lower end of the vehicle.

FIG. 18 is a diagram showing another example of laser beams separated by a diffraction unit.

FIG. 19 is a diagram showing an example when a lidar system is mounted at the upper end of the vehicle.

### DETAILED DESCRIPTION OF THE EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereafter, a device that requires autonomous driving information and/or 5G communication (5th generation mobile communication) that an autonomous vehicle requires are described through a paragraph A to a paragraph G.

A. Example of Block Diagram of UE and 5G Network

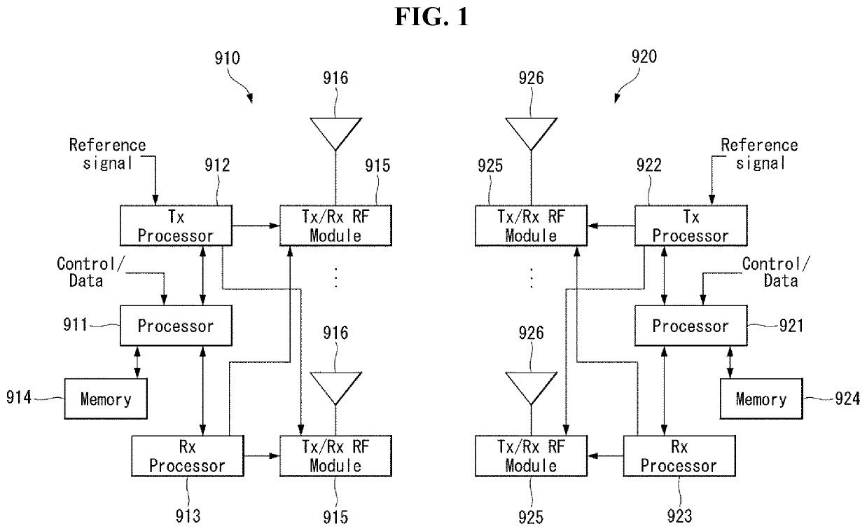

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

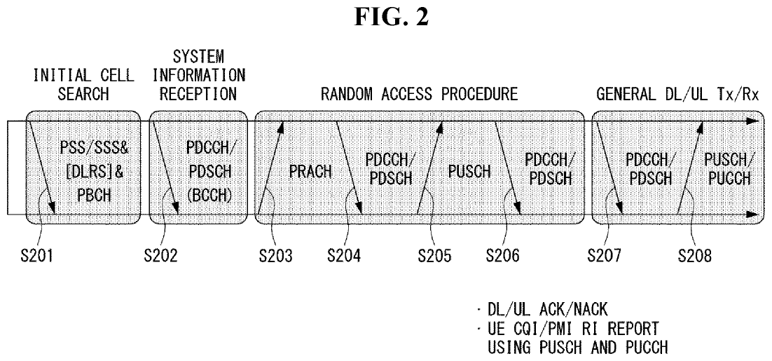

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequency Sect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

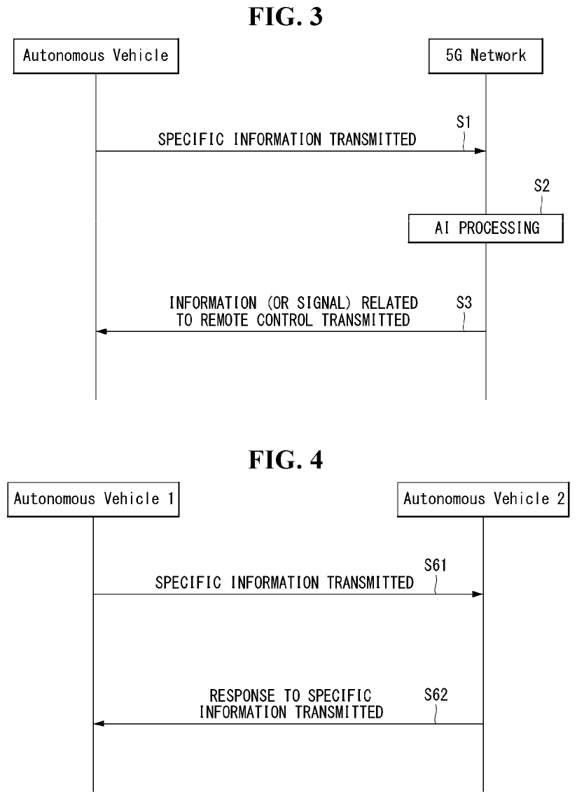

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present disclosure which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between Vehicles Using 5G Communication

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present disclosure which will be described later and applied or can complement the methods proposed in the present disclosure to make technical features of the methods concrete and clear.

Driving

(1) Exterior of Vehicle

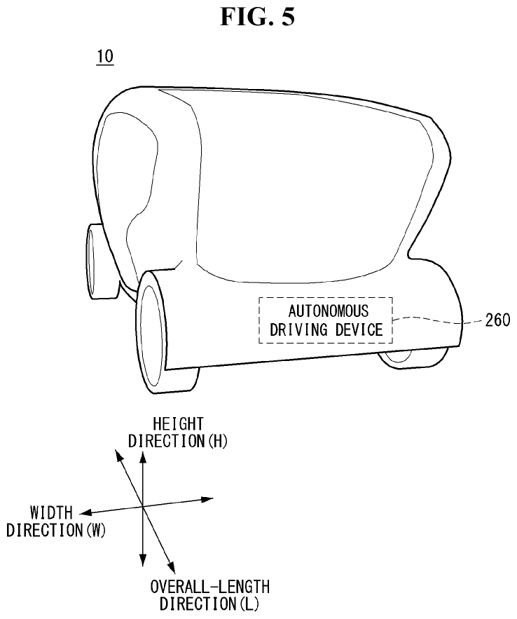

FIG. 5 is a diagram showing a vehicle according to an embodiment of the present disclosure.

Referring to FIG. 5, a vehicle 10 according to an embodiment of the present disclosure is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

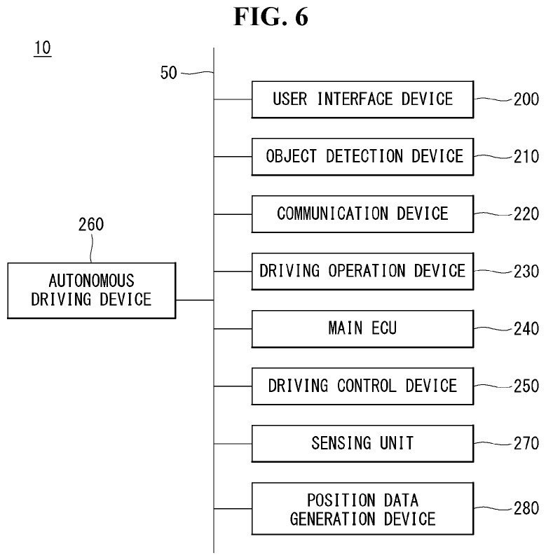

FIG. 6 is a control block diagram of the vehicle according to an embodiment of the present disclosure.

Referring to FIG. 6, the vehicle 10 may include a user interface device 200, an object detection device 210, a communication device 220, a driving operation device 230, a main ECU 240, a driving control device 250, an autonomous driving device 260, a sensing unit 270, and a position data generation device 280. The object detection device 210, the communication device 220, the driving operation device 230, the main ECU 240, the driving control device 250, the autonomous driving device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals.

The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3) Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present disclosure can exchange signals with external devices using only one of C-V2X and DSRC. Alternatively, the communication device of the present disclosure can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous driving device 260. For example, the driving control device 250 can control a power train, a steering device and a brake device on the basis of signals received by the autonomous driving device 260.

7) Autonomous Device

The autonomous driving device 260 can generate a route for self-driving on the basis of acquired data. The autonomous driving device 260 can generate a driving plan for traveling along the generated route. The autonomous driving device 260 can generate a signal for controlling movement of the vehicle according to the driving plan. The autonomous driving device 260 can provide the signal to the driving control device 250.

The autonomous driving device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous driving device 260 can perform switching from a self-driving mode to a manual driving mode or switching from the manual driving mode to the self-driving mode. For example, the autonomous driving device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

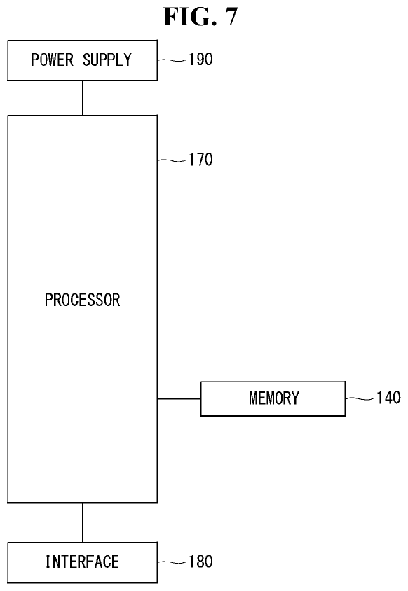

FIG. 7 is a control block diagram of the autonomous device according to an embodiment of the present disclosure.

Referring to FIG. 7, the autonomous driving device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous driving device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous driving device 260. The power supply 190 can be provided with power from a power source (e.g., a battery) included in the vehicle 10 and supply the power to each unit of the autonomous driving device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous driving device 260 may include at least one printed circuit board (PCB). The memory 140, the interface 180, the power supply 190 and the processor 170 may be electrically connected to the PCB.

(4) Operation of Autonomous Device

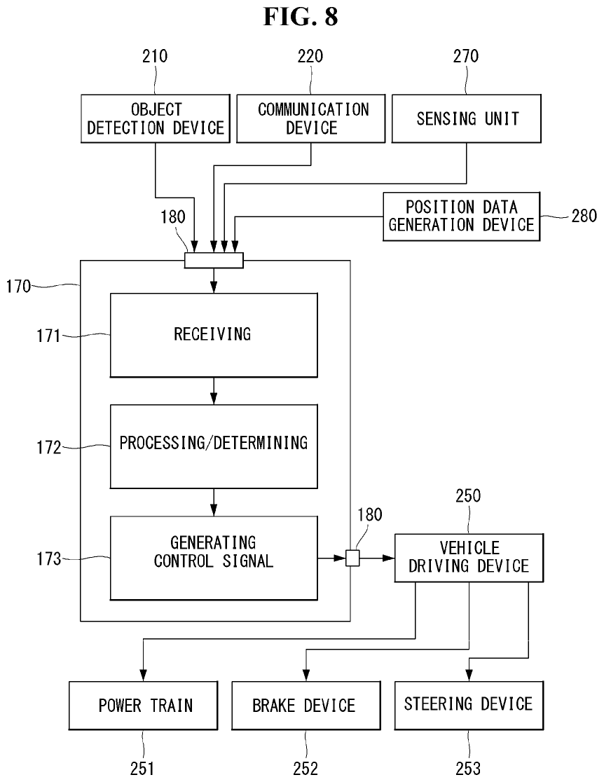

FIG. 8 is a diagram showing a signal flow in an autonomous vehicle according to an embodiment of the present disclosure.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

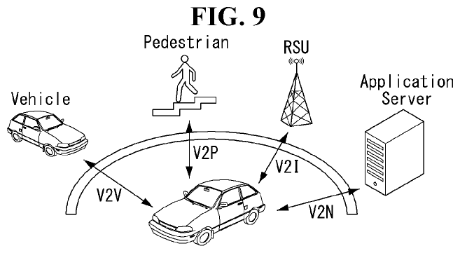

FIG. 9 shows an example of types of V2X applications.

Referring to FIG. 9, V2X communication includes communication between a vehicle and all entities such as V2V (Vehicle-to-Vehicle) referring to communication between vehicles, V2I (Vehicle to Infrastructure) referring to communication between a vehicle and an eNB or an RSU (Road Side Unit), V2P (Vehicle-to-Pedestrian) referring to communication between a vehicle and a UE that an individual (a pedestrian, a bicycle rider, a driver or a passenger in a vehicle) has, and V2N (vehicle-to-network).

V2X communication may refer to the same meaning as V2X sidelink or NR V2X or may refer to a wider meaning including V2X sidelink or NR V2X.

V2X communication may be applied to various services, for example, front collision warning, an automatic parking system, cooperative adaptive cruise control (CACC), control loss warning, traffic line warning, traffic vulnerable person safety warning, emergency vehicle warning, speed warning when driving on a bending road, and traffic flow control.

V2X communication can be provided through a PC5 interface and/or a Uu interface. In a wireless communication system that supports V2X communication, specific network entities for supporting communication between the vehicle and all entities may exist. For example, the network entities may be a BS (eNB), an RSU (road side unit), an application server (e.g., traffic safety server), or the like.

A UE that performs V2X communication may mean not only a common handled UE, but also a robot including a vehicle UE (V-UE), a pedestrian UE, a BS type (eNB type) RSU, a UE type (RSU), or a communication module, etc.

V2X communication may be directly performed between UEs or may be performed through the network entity (entities). A V2X operation mode can be classified in accordance with the performance manner of V2X communication.

V2X communication is required to support pseudonymity and privacy of a UE when using V2X applications such that an operator or a third part cannot track UE identity in an area where V2X is supported.

Terms that are frequently used in V2X communication are defined as follows.

RSU (Road Side Unit): An RSU is a V2X service-enabled device that can perform transmission/reception to/from a moving vehicle using a V2I service. Further, the RSU, which is a fixed infra entity supporting V2X applications, can exchange messages with another entity supporting the V2X applications. The RSU is a term that is frequently used in an existing ITS spec and the reason of introducing this term in a 3GPP spec is for enabling easily reading documents in an ITS industry. The RUS is a logical entity that combines an V2X application logic with the function of a BS (referred to as a BS-type RUS) or a UE (referred to as a UE-type RSU).

V2I service: A type of V2X service and an entity of which a side pertains to a vehicle and the other side pertains to an infrastructure.

V2P service: A type of V2X service in which a side is vehicle and the other side is a device that an individual has (e.g., a mobile UE device that a pedestrian, a bicycle rider, a driver, or a passenger carries).

V2X service: A 3GPP communication service type in which a transmission or reception device is related to a vehicle.

V2X-enabled UE: A UE supporting a V2X service.

V2V service: A V2X service type in which both sides of communication are vehicles.

V2V communication range: A direct communication range of two vehicles participating in a V2V service.

As V2X applications called V2X (Vehicle-to-Everything), as described above, there are four types of (1) vehicle-to-vehicle, (2) vehicle-to-infra, (3) vehicle-to-network (V2N), and (4) vehicle-to-pedestrian (V2P).

V2X communication can provide V2X applications of four types such as V2V, V2P, V2I, and V2N. These four types of V2X applications may use “co-operative awareness” to provide more intelligent services for end users. This refers to collecting knowledge (e.g., information received from an adjacent other vehicle or sensor equipment) regarding a corresponding area environment for entities such as a vehicle, a road-based facility, an application server, and a pedestrian to handle and share the corresponding knowledge to provide intelligent information such as cooperation collision warning or autonomous driving.

These intelligent transport services and related message sets are defined in automotive standards developing organizations (SDOs) outside 3GPP.

Three basic classes for providing ITS services: road safety, traffic efficiency and other applications are described in, for example, ETSI TR 102 638 V1.1.1: “Vehicular Communications; Basic Set of Applications; Definitions”.

A radio protocol architecture for a user plane for V2X communication and a radio protocol architecture for a control plane for V2X communication may be basically the same as a protocol stack architecture for sidelink. for the user plane includes a packet data convergence protocol (PDCP), a radio link control (RLC), a medium access control (MAC), and a physical layer (PHY), and the radio protocol architecture for the control plane may include radio resource control (RLC), an RLC, a MAC, and a physical layer. Further details of the protocol stack for V2X communication may refer to 3GPP TS 23.303, 3GPP TS 23.285, 3GPP TS 24.386, and the like.

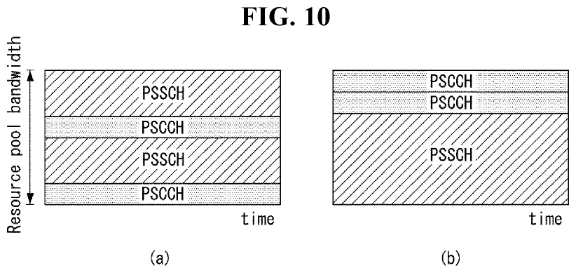

FIG. 10 exemplifies a resource allocation method in a sidelink in which V2X is used.

In the sidelink, as shown in part (a) of FIG. 10, different sidelink control channels (PSCCHs) may be allocated and spaced apart from each other in the frequency domain, and different sidelink shared channels (PSSCHs) may be allocated and spaced apart from each other. Alternatively, as shown in part (b) of FIG. 10, different PSCCHs may be consecutively allocated in the frequency domain and PSSCHs may also be consecutively allocated in the frequency domain.

In time division multiple access (TDMA) and frequency division multiple access (FDMA) systems, accurate time and frequency synchronization is essential. If time and frequency synchronization is not accurate, intersymbol interference (ISI) and intercarrier interference (ICI) may arise to degrade system performance. This is the same with V2X as well. In V2X, a sidelink synchronization signal (SLSS) may be used in the physical layer and master information block-sidelink-V2X (MIB-SL-V2X) may be used in the radio link control (RLC) layer for time/frequency synchronization.

A source of synchronization or criteria of synchronization in V2X will be described. The UE may acquire information about time/frequency synchronization from at least one of global navigation satellite systems (GNSS), serving cell (BS), or other neighboring UEs.

Specifically, the UE may be directly synchronized to the GNSS or synchronized to another UE that is time/frequency synchronized to the GNSS. In a case where the GNSS is configured as a synchronous source, the UE may calculate a DFN and a subframe number using coordinated universal time (UTC) and (pre)configured DFN (direct frame number) offset.

Alternatively, the UE may be directly synchronized to the BS or synchronized to another UE that is time/frequency synchronized to the BS. For example, if the UE is within network coverage, the UE may receive synchronization information provided by the BS and may be directly synchronized to the BS. Thereafter, the UE may provide the synchronization information to another neighboring UE. if a BS timing is configured as a criterion for synchronization, the UE may follow a cell associated with a corresponding frequency (if within the cell coverage at the frequency) or follow a primary cell or a serving cell (when outside the cell coverage at the frequency) for synchronization and downlink measurements.

A serving cell (BS) may provide a synchronization setup for a carrier used for V2X sidelink communication. In this case, the UE may follow the synchronization setup received from the BS. If no cell is detected from the carrier used for the V2X sidelink communication and no synchronization setup is received from the serving cell, the UE may follow a preset synchronization setup.

Alternatively, the UE may be synchronized to another UE that has not acquired the synchronization information either directly or indirectly from the BS or the GNSS. The source and preference of synchronization may be previously set to the UE or may be set via a control message provided by the BS.

The SLSS may be a sidelink-specific sequence and may include a primary sidelink synchronization signal (PSSS) and a secondary sidelink synchronization signal (SSSS).

Each SLSS may have a physical layer sidelink synchronization identity, and the value may be, for example, any of 0 to 335. A synchronization source may be identified depending on which of the above values is used. For example, 0, 168, and 169 may refer to Global Navigation Satellite System (GNSS), 1 to 167 may refer to BS, and 170 to 335 may refer to outside coverage. Alternatively, values 0 to 167 among the physical layer sidelink synchronization ID are values used by the network, and 168 to 335 may be values used outside the network coverage.

The UE providing synchronization information to another UE may be considered to operate as a synchronization reference. The UE may additionally provide information on synchronization together with the SLSS via a SL-BCH (sidelink broadcast channel).

There are transmission modes 1, 2, 3 and 4 in the sidelink.

In a transmission mode 1/3, the BS performs resource scheduling through the PDCCH (more specifically, DCI) to the UE 1, and the UE 1 performs D2D/V2X communication with the UE 2 according to the resource scheduling. The UE 1 may transmit sidelink control information (SCI) through the physical sidelink control channel (PSCCH) to the UE 2 and then transmit the data based on the SCI through a physical sidelink shared channel (PSSCH). Transmission mode 1 may be applied to D2D, and transmission mode 3 may be applied to V2X.

The transmission mode 2/4 may be a mode in which the UE performs scheduling by itself. More specifically, the transmission mode 2 is applied to the D2D, and the UE may perform the D2D operation by selecting resource by itself from the configured resource pool. Transmission mode 4 is applied to V2X, and the UE may perform a V2X operation after selecting resources by itself from a selection window through a sensing process. The UE 1 may transmit the SCI through the PSCCH to the UE 2 and then transmit the data based on the SCI through the PSSCH. Hereinafter, the transmission mode may be abbreviated as a mode.

The control information transmitted by the BS to the UE through the PDCCH is referred to as DCI (downlink control information), while the control information transmitted by the UE to the other UE through the PSCCH may be referred to as SCI. The SCI may convey sidelink scheduling information. There may be several formats in SCI, for example, SCI format 0 and SCI format 1.

SCI format 0 may be used for scheduling of the PSSCH. The SCI format 0 may include a frequency hopping flag (1 bit), a resource block allocation and a hopping resource allocation field (the number of bits may vary depending on the number of resource blocks of the sidelink), a time resource pattern, an MCS (modulation and coding scheme), a time advance indication, a group destination ID, and the like.

The SCI Format 1 may be used for scheduling of the PSSCH. The SCI format 1 includes priority, resource reservation, frequency resource location of initial transmission and retransmission (the number of bits may vary depending on the number of subchannels of the sidelink), a time gap between initial transmission and retransmission, MCS, retransmission index, and the like.

The SCI format 0 may be used for transmission modes 1 and 2, and the SCI format 1 may be used for transmission modes 3 and 4.

Hereinafter, resource allocation in mode 3 and mode 4 applied to V2X will be described in detail. First, mode 3 will be described.

Mode 3 may be scheduled resource allocation. The UE may be in RRC_CONNECTED state to transmit data.

FIG. 10 illustrates a case where a UE performs a mode 3 operation.

The UE may request the BS for transmission/reception resources, and the BS may schedule the resource(s) for the UE regarding the sidelink control information and/or transmission/reception of data. Here, a sidelink SPS may be supported for scheduled resource allocation. The UE may transmit/receive sidelink control information and/or data with another UE using the allocated resources.

The UE may request the BS for transmission/reception resources, and the BS may schedule the resource(s) for the UE regarding the sidelink control information and/or transmission/reception of data. Here, a sidelink SPS may be supported for scheduled resource allocation. The UE may transmit/receive sidelink control information and/or data with another UE using the allocated resources.

Mode 4 may be UE autonomous resource selection. The UE may perform sensing for (re)selection of sidelink resources. The UE may randomly select/reserve sideline resource among remaining resources excluding specific resource on the basis of a sensing result. The UE may perform up to two parallel independent resource reservation processes.

As described above, the UE may perform sensing to select a mode 4 transmission resource.

For example, the UE may recognize transmission resources reserved by other UEs or resources used by other UEs through sensing in a sensing window, exclude the same from the selection window, and randomly select resource from less-interfered resource among the remaining resources.

For example, within a sensing window, the UE may decode a PSCCH including information on a period of the reserved resources and measure a PSSCH RSRP on the periodically determined resources on the basis of the PSCCH. Resources whose PSSCH

RSRP value exceeds a threshold may be excluded from the selection window. Thereafter, the UE may randomly select sidelink resources from the remaining resources in the selection window.

The UE may measure received signal strength indication (RSSI) of periodic resources in the sensing window to identify resources with less interference corresponding to lower 20%, for example. The UE may then select sidelink resource among the resources included in the selection window among the periodic resources. For example, such a method may be used if decoding of PSCCH fails.

The 5G communication technology described above can be applied in combination with methods proposed in the present disclosure to be described below or can be added to make the technical characteristics of the methods proposed in the present disclosure embodied or clear.

Hereafter, a lidar system and an autonomous driving system using the lidar system according to an embodiment of the present disclosure are described in detail. According to a lidar system of the present disclosure, one or more of an autonomous vehicle, an AI device, and an external device may be linked with an artificial intelligence module, a drone ((Unmanned Aerial Vehicle, UAV), a robot, an AR (Augmented Reality) device, a VR (Virtual Reality) device, a device associated with 5G services, etc. Hereafter, embodiments will be described mainly with reference to an example in which a lidar system is applied to an autonomous vehicle, but it should be noted that the present disclosure is not limited thereto.

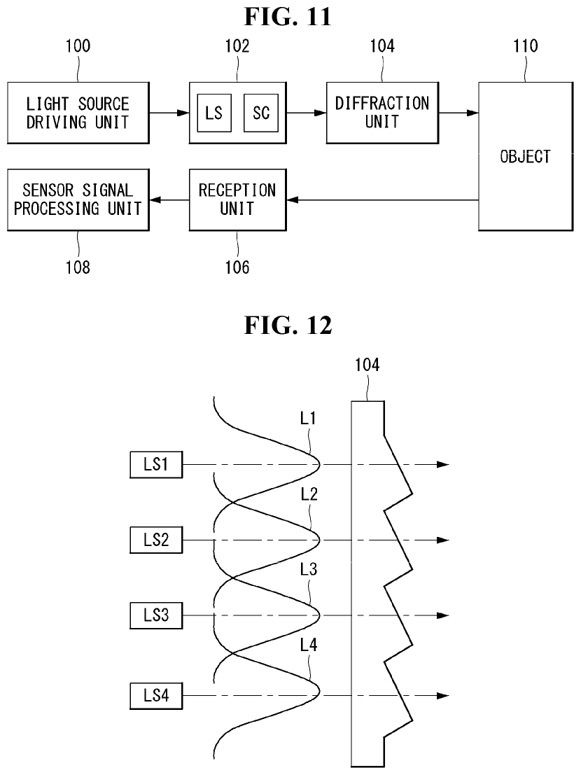

The object detection device 210 may include the lidar system of FIGS. 11 to 15.

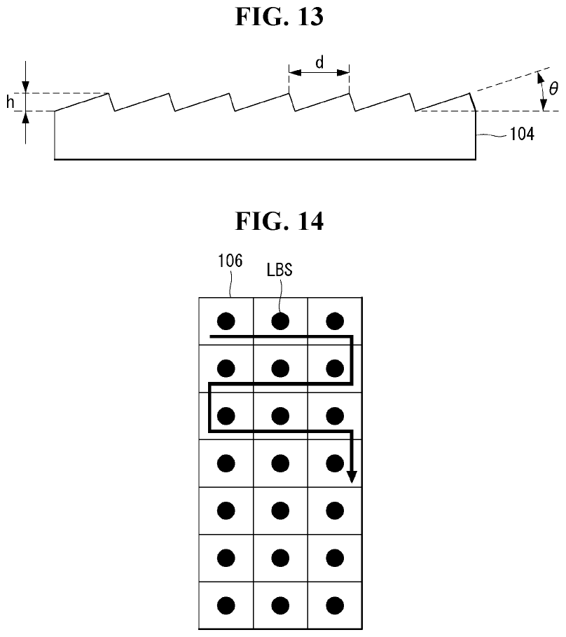

FIG. 11 is a block diagram showing a lidar system according to an embodiment of the present disclosure. FIG. 12 is a diagram showing light sources and a diffraction element. FIG. 13 is a diagram showing an example of a diffraction element. FIG. 14 is a diagram showing an example of a light sensor array of a reception sensor.

Referring to FIGS. 11 to 14, a lidar system includes a light source driving unit 100, a light emission unit 102, a diffraction unit 104, a reception sensor 106, and a sensor signal processing unit 108.

The light source driving unit 100 drives light sources LS1˜LS4 of the light emission unit 102 by supplying a current to the light sources LS1˜LS4. The light source driving unit 100 can adjust a driving current of each of the light sources LS1˜LS4 in accordance with the mounted position of the lidar system. For example, the light source driving unit 100 can increase the current of light sources for long-distance sensing more than those of light sources for short-distance and medium-distance sensing. Further, the light source driving unit 100 can adjust the driving current of each of the light sources LS1˜LS4 in accordance with driving environment information on a route received through a network. The driving environment information may include landform information of a route, traffic congestion information, weather, etc.

The light emission unit 102 includes linear light source LS and a scanner SC. The linear light source LS may include two or more light sources LS1˜LS4. The light emission unit 102 may further include a scanner SC that scans an object 110 by moving light that is generated from the light sources LS1˜LS4.

The light sources LS1˜LS4 include several laser light sources vertically arranged, as shown in FIG. 12, whereby they can be implemented as linear light sources. Although a four-channel light source array in which four laser light sources are vertically arranged is exemplified in FIG. 12, the present disclosure is not limited thereto. The vertically arranged light sources LS1˜LS4 generate laser beams in a vertical linear light source type.

The light sources LS1˜LS4 can generate laser beams having the same wavelength or wavelengths different from one another. The laser light wavelength may be 905 nm or 1550 nm. The light sources LS1˜LS4 can be classified into light sources for short-distance and medium-distance sensing and light sources for long-distance sensing. Here, the short distance may be a distance of 20˜50 m from a vehicle. The medium distance may be a distance of 50 m from a vehicle. The long distance may be a distance of over 100 m from a vehicle. It is preferable that a light source for long-distance sensing is a laser having a wavelength that has a low degree of influence on the retinas of human even if light power is increased, for example, 1550 nm.

The laser light source of 905 nm can be implemented as a semiconductor diode laser based on InGaAs/GaAs and can emit laser light of high power. The peak power of the semiconductor diode laser based on InGaAs/GaAs is 25 W in one emitter. In order to increase the power of the semiconductor diode laser based on InGaAs/GaAs, three emitters are combined in a stack structure, thereby being able to output laser light of 75 W. The semiconductor diode laser based on InGaAs/GaAs can be implemented in a small size at a low cost. The driving mode of the semiconductor diode laser based on InGaAs/GaAs is a spatial mode and a multi mode.

The laser light source of 1550 nm can be implemented as a fiber laser, a DPSS (Diode Pumped Solid State) laser, a semiconductor diode laser, etc. As a representative example of the fiber laser, there is an erbium-doped fiber laser. The fiber laser of 1550 nm can emit a laser of 1550 nm through an erbium-doped fiber, using a diode laser as a pump laser. The peak power of the fiber laser of 1550 nm can be up to several kW. The operation modes of the fiber laser of 1550 nm are a spatial mode and a few mode. The light quality is high and the aperture size is small in the fiber laser of 1550 nm, so it is possible to detect an object with high resolution. The DPSS laser can emit laser light of 1534 nm through a laser crystal such as MgAlO and YVO, using a diode layer as a pump laser. The semiconductor diode layer of 1550 nm can be implemented as a semiconductor diode layer based on InGaAsP/InP and the peak power thereof is tens of watts (W). The semiconductor diode layer of 1550 nm is smaller in size than the fiber laser.

Light generated from the light sources LS1˜LS4 travels into the scanner SC. The scanner SC reciprocates the light from the light sources LS1˜LS4 to implement a field of angle set in advance. The scanner SC may be implemented as a galvano scanner or a MEMS scanner.

The light sources LS1˜LS4 are implemented in a vertical N-channel light source array (N is a natural number of 2 or more) by being vertically arranged, as shown in FIG. 12, so laser beams can be generated as linear light sources. In this case, the scanner SC can be implemented as a one-dimensional (1D) scanner that horizontally reciprocates a vertical light source. Accordingly, the present disclosure can reduce the size and weight of the light emission unit 102, can reduce the costs, and can increase mass productivity.

The diffraction unit 104 is disposed ahead of the light sources LS1˜LS4 in the transmission direction of light. The light sources LS1˜LS4 and the diffraction unit 104 may be integrated into one module.

The diffraction unit 104 separates an incident laser beam from the light emission unit 102 with predetermined spectrum ratio and angle, using a diffractive optical element (DOE), thereby separating the laser beam into several point light sources more than the number of the light sources LS1˜LS4.

The incident laser beam from each of the light sources LS1˜LS4 is not uniform in light intensity in light distribution including a main lobe having high light intensity at the center and a side lobe having low light intensity. When such laser beams are reflected by the object 110 and travel into the reception sensor 106, the side lobe light of the laser beams is received to adjacent light sensors, thereby causing the problem of cross-talk.

The diffraction unit 104 can increase a signal-to-noise ratio (SNR) by increasing the efficiency of the laser beams that are radiated from the light sources LS1˜LS4 by separating a linear light source with non-uniform light intensity into several point linear sources. The diffraction unit 104 makes light distribution of linear light sources, which are radiated to the object 110, uniform by separating the laser beams from the light sources LS1˜LS4, thereby being able to increase light uniformity and minimize cross-talk between light sensors of the reception sensor 106.

An example of the diffractive optical element (DOE) is shown in FIG. 13. The diffractive optical element (DOE) includes several spectrum patterns that form grooves. A laser beam that is radiated to one spectrum pattern is separated into many point light sources and transmitted.

In FIG. 12, the larger the pitch d between spectrum patterns, the larger the spectrum angle can be. The pitch of the spectrum patterns and the angle θ of the spectrum pattern may be in an inverse proportion relationship. The depth h of the spectrum patterns can adjust the light intensity and the spectrum angle. The smaller the depth h of the spectrum patterns, the large the light intensity can be. The spectrum angle may be changed in accordance with the wavelength of the light traveling into the diffractive optical element (DOE). By appropriately designing the spectrum pattern pitch d, depth h, and angle θ of the diffractive optical element (DOE), it is possible to implement desired spectrum ratio and angle in accordance with various use cases.

A laser beam that passes through the diffraction unit 104 is reflected by the object 110 and received to the reception sensor 106. The reception sensor 106, as shown in FIG. 14, may be implemented as a light sensor array in which light sensors are arranged vertically and horizontally in a matrix shape.

It is a laser beam of a point light source type separated by the diffraction unit 104 and radiated to the object 110. Such a laser beam is reflected by the object 110 and received to the light sensor array. In FIG. 14, “LBS” indicates light spots on the light sensors and the arrow indicates the scan direction of the light sensor array that is synchronized with the scanner SC of the light emission unit 102. The light sensors convert light received from the object 110 into an electrical signal, using a photodiode.

The signal processing unit 108 converts output of the reception sensor 106 into a voltage, amplifies it, and then converts the amplified signal into a digital signal using an analog-to-digital converter (ADC). The signal processing unit 108 determines the distance from the object 110, the shape of the object 110, etc. by analyzing the digital data input from the ADC using a TOF (Time of Flight) algorithm or a phase-shift algorithm.

The signal processing unit 108 can provide sensor data including information about the distance from the object 110 and the shape of the object 110 to the autonomous device 260. The autonomous device 260 includes an autonomous device that receives sensor data input from the lidar system and reflects detected object information to movement control of a vehicle.

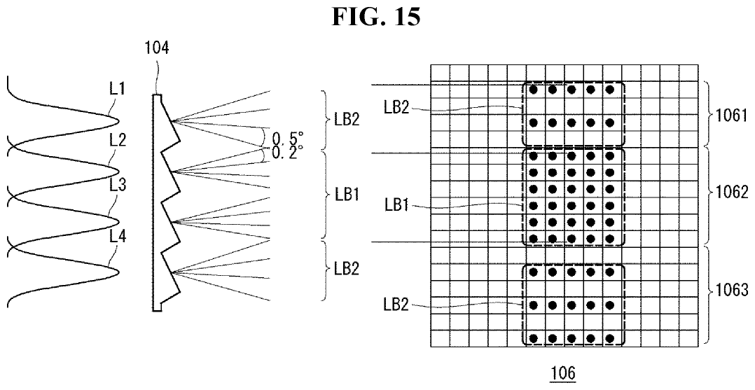

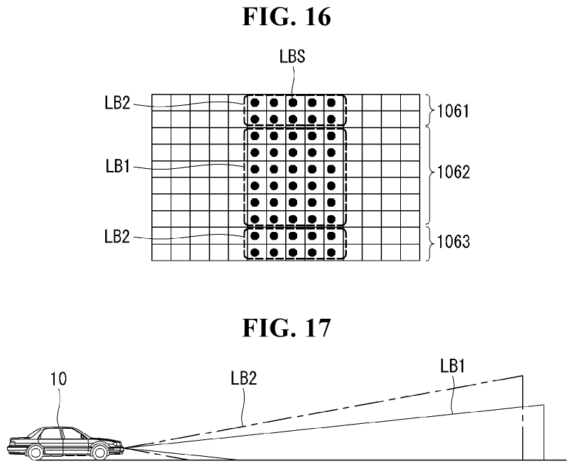

FIGS. 15 and 16 are diagrams showing laser beams that are separated by a diffraction optical element and light spots on a light sensor array.

Referring to FIG. 15, laser beams L1˜L4 generated from light sources LS1˜LS4 are separated by a diffraction unit 14.

By adjusting the pitch d, depth h, and angle θ of the spectrum pattern of the diffractive optical element (DOE), it is possible to change the angles of separated beams in accordance with the position of the diffractive optical element (DOE). For example, the diffractive optical element (DOE) can increase resolution by reducing a spectrum angle at a center portion that is accounted in safe driving of a vehicle 10, and can increase the spectrum angle at the upper and lower surrounding portions. In the example of FIG. 15, it is exemplified that the spectrum angle at the center portion of the light distribution is 0.2 degrees and the spectrum angle at upper and lower surrounding portions is 0.5 degrees, but the present disclosure is not limited thereto. When the spectrum angle at the upper and lower surrounding portions of light distribution of laser beams that are radiated to the object 110 is increased, it is possible to sense an object or an obstacle with low resolution, but a wide view of angle. This spectrum angle control method of a lidar system is impossible in a system that uses only linear light sources.

The light sensor array of the reception sensor 106 includes: a first sensing unit 1061 that senses a point light source LB2 that is radiated to the object 110 through the center portion of the diffractive optical element (DOE); a second sensing unit 1062 that senses a point light source LB1 that is radiated to the object 110 through an upper surrounding portion of the diffractive optical element (DOE); and a third sensing unit 1063 that senses a point light source LB2 that is radiated to the object 110 through a lower surrounding portion of the diffractive optical element (DOE). The point light sources separated by the diffractive optical element (DOE) are respectively received to the light sensors of the light sensor array.

When the light sensors are clustered in the reception sensor 106 in accordance with the density of the light spots LBS as shown in FIG. 16, it is possible to increase the scan speed of the light sensor array that is sequentially scanned. For example, for the first and third sensing units 1061 and 1063 that sense the object 110 with low resolution, it is possible to increase the scan speed and the frame speed by simultaneously driving adjacent light sensors. It is possible to drive light sensors individually or in a cluster, depending on use cases. When surrounding sensors are driven as one sensor at a portion with low density of light spots LBS, the scan speed of the light sensor array can be correspondingly increased.

The lidar system 10 may be disposed at one or more positions of the front, the rear, and the sides of a vehicle, and may be disposed at the lower end of a vehicle. FIG. 17 is a diagram showing an example when a lidar system is mounted at the lower end of the vehicle 10. FIG. 19 is a diagram showing an example when a lidar system is mounted at the upper end of the vehicle 10.

Referring to FIGS. 15 to 19, a point light source LB1 traveling with a narrow spectrum angle by the diffraction unit 104 is radiated to the center portion of the light distribution, thereby being able to sense the object 110 with high resolution. A point light source LB2 traveling with a wide spectrum angle by the diffraction unit 104 can sense the object 110 with low resolution.

The spectrum ratio and angle of the diffraction unit 104 can be changed in accordance with the mounted position of the lidar system.

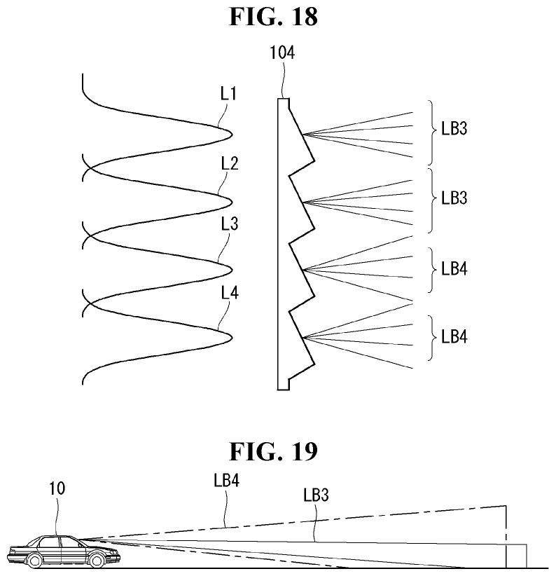

FIG. 18 is a diagram showing another example of laser beams separated by a diffraction unit. FIG. 19 is a diagram showing an example when a lidar system is mounted at the upper end of a vehicle.

Referring to FIGS. 18 and 19, when a lidar system is disposed at the upper end of a vehicle 10, a point light source LB3 can travel with a narrow spectrum angle from the upper end of the diffraction unit 104. Further a point light source LB4 can travel with a wide spectrum angle from the lower end of the diffraction unit 104.

Various embodiments of the lidar system of the present disclosure are described hereafter.

### Embodiment 1

A lidar system may include: two or more light sources that generate light of a linear light source type; a light emission unit that includes a diffractive optical element disposed ahead of the light sources and separating incident light from the light sources into several point light sources, and a scanner moving the light separated by the diffractive optical element, and radiates light of a point light source to an object; and a reception sensor that converts light received after reflected by the object into an electrical signal. Spectrum angles of point light sources that have passed through the diffractive optical element may be different in accordance with a position of the diffractive optical element.

### Embodiment 2

The light sources may be vertical linear light sources. The scanner may include a one-dimensional scanner that horizontally reciprocates the light of a linear light source type.

### Embodiment 3

The reception sensor may include a light sensor array in which light sensors are arranged vertically and horizontally in a matrix shape

### Embodiment 4

A spectrum angle of light passing through a center portion of the diffractive optical element may be smaller than that of light passing through upper and lower surrounding portions of the diffraction unit.

### Embodiment 5

The light sensor array may include: a first sensing unit that senses a point light source that has low resolution and is radiated to the object through the center portion of the diffractive optical element; a second sensing unit that senses a point light source that has high resolution and is radiated to the object through the upper surrounding portion of the diffractive optical element; and a third sensing unit that senses a point light source that has low resolution and is radiated to the object through the lower surrounding portion of the diffractive optical element.

### Embodiment 6

The lidar system may further include a light source driving unit that drives the light sources by supplying a current to the light sources and changes intensity of the current that is supplied to the light sources in accordance with a sensing distance.

### Embodiment 7

The light source driving unit may adjust the driving current of each of the light sources in accordance with driving environment information on a route received through a network.

Various embodiments of the autonomous driving system of the present disclosure are described hereafter.

### Embodiment 1

An autonomous driving system includes: a lidar system that senses an object outside a vehicle by radiating a laser beam to the outside of the vehicle; and an autonomous device that receives sensor data input from the lidar system and reflects information of the object to movement control of the vehicle.

The lidar system may include: two or more light sources that generate light of a linear light source type; a light emission unit that includes a diffractive optical element disposed ahead of the light sources and separating incident light from the light sources into several point light sources, and a scanner moving the light separated by the diffractive optical element, and radiates light of a point light source to an object; and a reception sensor that converts light received after reflected by the object into an electrical signal.

Spectrum angles of point light sources that have passed through the diffractive optical element may be different in accordance with a position of the diffractive optical element.

### Embodiment 2

The light sources may be vertical linear light sources. The scanner may include a one-dimensional scanner that horizontally reciprocates the light of a linear light source type.

### Embodiment 3

The reception sensor may include a light sensor array in which light sensors are arranged vertically and horizontally in a matrix shape

### Embodiment 4

A spectrum angle of light passing through a center portion of the diffractive optical element may be smaller than that of light passing through upper and lower surrounding portions of the diffraction unit.

### Embodiment 5

The light sensor array may include: a first sensing unit that senses a point light source that has low resolution and is radiated to the object through the center portion of the diffractive optical element; a second sensing unit that senses a point light source that has high resolution and is radiated to the object through the upper surrounding portion of the diffractive optical element; and a third sensing unit that senses a point light source that has low resolution and is radiated to the object through the lower surrounding portion of the diffractive optical element.

### Embodiment 6

The lidar system may further include a light source driving unit that drives the light sources by supplying a current to the light sources and changes intensity of the current that is supplied to the light sources in accordance with a sensing distance.

### Embodiment 7

The light source driving unit may adjust the driving current of each of the light sources in accordance with driving environment information on a route received through a network.

The present disclosure can improve a signal-to-noise ratio (SNR) by increasing the efficiency of emitted beams by disposing a diffractive optical element ahead of light sources and separating laser beams generated from the light source into several point light sources.

The present disclosure can increase light uniformity and minimize cross-talk between light sensors of a reception sensor by making light distribution of point light sources, which are radiated to an object, uniform using the diffractive optical element.

The present disclosure can implement a lidar system that is small and light and can reduce costs by implementing an optical system of a light emission unit using a linear light source, a diffractive optical element, and one one-dimensional scanner.

The present disclosure can flexibly apply point light source distribution of a lidar system in accordance with various use cases such as a lidar mounting position on a vehicle and a driving environment.

The effects of the present disclosure are not limited to the effects described above and other effects can be clearly understood by those skilled in the art from the following description.

The present disclosure can be achieved as computer-readable codes on a program-recoded medium. A computer-readable medium includes all kinds of recording devices that keep data that can be read by a computer system. For example, the computer-readable medium may be an HDD (Hard Disk Drive), an SSD (Solid State Disk), an SDD (Silicon Disk Drive), a ROM, a RAM, a CD-ROM, a magnetic tape, a floppy disk, and an optical data storage, and may also be implemented in a carrier wave type (for example, transmission using the internet). Accordingly, the detailed description should not be construed as being limited in all respects and should be construed as an example. The scope of the present disclosure should be determined by reasonable analysis of the claims and all changes within an equivalent range of the present disclosure is included in the scope of the present disclosure.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A lidar system comprising:
two or more light sources that generate light of a linear light source type;
a light emission unit that includes a diffractive optical element disposed ahead of the light sources and separating incident light from the light sources into several point light sources, and a scanner moving the light separated by the diffractive optical element, and radiates light of a point light source to an object; and
a reception sensor that converts light received after reflected by the object into an electrical signal,
wherein spectrum angles of point light sources that have passed through the diffractive optical element are different in accordance with a position of the diffractive optical element.

2. The lidar system of claim 1, wherein the light sources are vertical linear light sources, and
the scanner includes a one-dimensional scanner that horizontally reciprocates the light of a linear light source type.

3. The lidar system of claim 2, wherein the reception sensor includes a light sensor array in which light sensors are arranged vertically and horizontally in a matrix shape.

4. The lidar system of claim 3, wherein a spectrum angle of light passing through a center portion of the diffractive optical element us smaller than that of light passing through upper and lower surrounding portions of the diffraction unit.

5. The lidar system of claim 4, wherein the light sensor array includes:
a first sensing unit that senses a point light source that has low resolution and is radiated to the object through the center portion of the diffractive optical element;
a second sensing unit that senses a point light source that has high resolution and is radiated to the object through the upper surrounding portion of the diffractive optical element; and
a third sensing unit that senses a point light source that has low resolution and is radiated to the object through the lower surrounding portion of the diffractive optical element.

6. The lidar system of claim 1, further comprising a light source driving unit that drives the light sources by supplying a current to the light sources and changes intensity of the current that is supplied to the light sources in accordance with a sensing distance.

7. The lidar system of claim 6, wherein the light source driving unit adjusts the driving current of each of the light sources in accordance with driving environment information on a route received through a network.

8. An autonomous driving system comprising:
a lidar system that senses an object outside a vehicle by radiating a laser beam to the outside of the vehicle; and
an autonomous device that receives sensor data input from the lidar system and reflects information of the object to movement control of the vehicle,
wherein the lidar system includes: two or more light sources that generate light of a linear light source type; a light emission unit that includes a diffractive optical element disposed ahead of the light sources and separating incident light from the light sources into several point light sources, and a scanner moving the light separated by the diffractive optical element, and radiates light of a point light source to an object; and a reception sensor that converts light received after reflected by the object into an electrical signal, and
spectrum angles of point light sources that have passed through the diffractive optical element are different in accordance with a position of the diffractive optical element.

9. The autonomous driving system of claim 8, wherein the light sources are vertical linear light sources, and
the scanner includes a one-dimensional scanner that horizontally reciprocates the light of a linear light source type.

10. The autonomous driving system of claim 9, wherein the reception sensor includes a light sensor array in which light sensors are arranged vertically and horizontally in a matrix shape.

11. The autonomous driving system of claim 10, wherein a spectrum angle of light passing through a center portion of the diffractive optical element us smaller than that of light passing through upper and lower surrounding portions of the diffraction unit.

12. The autonomous driving system of claim 11, wherein the light sensor array includes:
a first sensing unit that senses a point light source that has low resolution and is radiated to the object through the center portion of the diffractive optical element;
a second sensing unit that senses a point light source that has high resolution and is radiated to the object through the upper surrounding portion of the diffractive optical element; and
a third sensing unit that senses a point light source that has low resolution and is radiated to the object through the lower surrounding portion of the diffractive optical element.

13. The autonomous driving system of claim 9, the lidar system further includes a light source driving unit that drives the light sources by supplying a current to the light sources and changes intensity of the current that is supplied to the light sources in accordance with a sensing distance.

14. The autonomous driving system of claim 13, wherein the light source driving unit adjusts the driving current of each of the light sources in accordance with driving environment information on a route received through a network.
